(19) United States
(12) Patent Application Publication
(10) Pub. No.: US 2016/0121415 A1
(43) Pub. Date: May 5, 2016

(54) APPARATUS AND METHOD FOR CUTTING SEMI/NON-CONDUCTOR USING WEDM

(71) Applicant: National Taiwan University of Science and Technology, Taipei (TW)

(72) Inventors: Chun-Liang Kuo, Taipei (TW); Jeng-Ywan Jeng, Taipei (TW)

(73) Assignee: National Taiwan University of Science and Technology, Taipei (TW)

(21) Appl. No.: 14/792,786

(22) Filed: Jul. 7, 2015

(30) Foreign Application Priority Data
Nov. 5, 2014 (TW) 103138441

(51) Int. Cl. B23H 7/02; B23H 7/04; B23H 1/08

(52) U.S. Cl. CPC B23H 7/02; B23H 1/08; B23H 7/04

(57) ABSTRACT

A wire electrical discharge machining (WEDM) method is disclosed, the WEDM method comprising steps of: (a) providing one of a non-conductive and a weakly conductive object having a to-be-cut surface; (b) providing one of a wire and a cutting tool having a cutting blade edge to cut the object along the to-be-cut surface; (c) providing a conductive medium to adhere to the to-be-cut surface via the cutting blade edge; and (d) applying an electric current between the one of the wire and the cutting tool, and the to-be-cut surface adhered to the conductive medium such that the to-be-cut surface is melted.

### CROSS-REFERENCE TO RELATED APPLICATION AND CLAIM OF PRIORITY

The application claims the benefit of the Taiwan Patent Application No. 103138441, filed on Nov. 5, 2014, at the Taiwan Intellectual Property Office, the disclosures of which are incorporated herein in their entirety by reference.

### FIELD OF THE INVENTION

The present invention relates to a wire electrical discharge machining (WEDM) apparatus and method thereof, specifically for cutting nonconductors or weak conductors using WEDM, wherein the weak conductor is a poor conductor of heat or electricity.

### BACKGROUND OF THE INVENTION

In the prior art, cutting machining technology for nonconductors or weak conductors is dependent on traditionally abrasive wire cutting machining, the produced cutting stress will crack the workpiece, change the size thereof, and cause many negative impacts, for example, the cutting thickness is restricted and the accuracy is affected. Therefore, the machining efficiency and the material removal rate (MRR) decreases, and the material choice and manufacturing cost burden are involved when applied to a cutting operation for the semiconductor.

In another, a conductive resin is coated onto the polished monocrystalline silicon tablet, then rough machining is performed in water, and finally fine machining is performed in oil; however, the conductive efficiency in this manufacturing process can not be compared with traditional wire saws.

In another, a WEDM machine is developed to cut a silicon wafer, wherein a 6-inch polycrystalline silicon wafer is cut using a 0.2 mm (200 μn)-diameter wire. However, experimental results show that the process is not superior to the wire saw manufacturing process.

In another, a series of studies of the properties of the WEDM for monocrystalline silicon was conducted, including the operating voltage and current, and the wire conductor tension and feed rate.

Furthermore, in a process of using WEDM to cut layered Carbon Fiber Reinforced Plastic (CFRP)-composite stacks, the CFRP was successfully cut using the electrical conductivity of the upper and lower splints and high temperature characteristics from an electrical discharge.

However, it is difficult to use the traditional cutting manufacturing process for a poor conductor of heat or electricity, and the shape of the cut itself is not fine enough. Therefore, a manufacturing process using heat as the cutting energy is disclosed in the present invention, which is sufficient to improve production efficiency and reduce the manufacturing process costs.

In order to overcome the drawbacks in the prior art, an apparatus and method for cutting semi/non-conductors using WEDM is disclosed. The particular design in the present invention not only solves the problems described above, but is also easy to implement. Thus, the present invention has utility for the industry.

### SUMMARY OF THE INVENTION

In the present invention, two metal pieces are respectively configured on the upper and lower surface of a poor conductor of heat or electricity, by the application of a high voltage such that the metal pieces are melted from the thermal effect to release metal slag as a conductive medium or a thermally conductive medium, the metal slag adheres to the surface of the poor conductor of heat or electricity for processing via a metal wire, and creates a closed loop circuit. Then a high electric current with short-duration pulses is used to produce continuous electrical discharge machining, the instantly high temperature from the electrical discharge can melt the poor conductor of heat or electricity, and thus the cutting manufacturing process for the poor conductor of heat or electricity is completed. There is no restriction on the residual stress or cutting thickness, and there is no need to immerse the workpiece in an electrolyte for electroplating or other dipping bath operations, etc., which also achieves an energy-saving effect.

In accordance with one aspect of the present invention, a wire electrical discharge machining (WEDM) method is disclosed. The WEDM method includes steps of (a) providing one of a non-conductive and a weakly conductive object having a to-be-cut surface; (b) providing one of a wire and a cutting tool having a cutting blade edge to cut the object along the to-be-cut surface; (c) providing a conductive medium to adhere to the to-be-cut surface via the cutting blade edge; and (d) applying an electric current between the one of the wire and the cutting tool, and the to-be-cut surface adhered to the conductive medium such that the to-be-cut surface is melted.

In accordance with another aspect of the present invention, a wire electrical discharge machining (WEDM) apparatus for applying the WEDM to a non-conductive or weakly conductive objects is disclosed, wherein the one object has a to-be-cut surface, and the WEDM apparatus includes one of a wire and a cutting tool having a cutting blade to cut the object along the to-be-cut surface; a conductive medium source providing a conductive medium to adhere to the to-be-cut surface via the cutting blade; and an electric current source that applies an electric current between the one of the wire and the cutting tool and the to-be-cut surface adhered to the conductive medium such that the to-be-cut surface is melted.

In accordance with a further aspect of the present invention, a wire electrical discharge machining (WEDM) apparatus for applying the WEDM to a non-conductive or weakly conductive object is disclosed, wherein the one object has a to-be-cut surface, and the WEDM apparatus includes one of a wire and a cutting tool having a cutting blade to cut the object along the having to-be-cut surface; and a conductive medium source providing a conductive medium to adhere to the to-be-cut surface via the cutting blade, wherein the to-be-cut surface is melted by an application of an electric current between the one of the wire and the cutting tool and the to-be-cut surface adhered to the conductive medium.

The above objectives and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a schematic flow chart of one embodiment in the present invention.

FIGS. 2-7 are schematic diagrams of another embodiment in the present invention.

FIG. 8 is a schematic diagram of another embodiment in the present invention.

FIG. 9 is a schematic diagram showing the WEDM configuration and an arrangement for another embodiment in the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; they are not intended to be exhaustive or to be limited to the precise form disclosed.

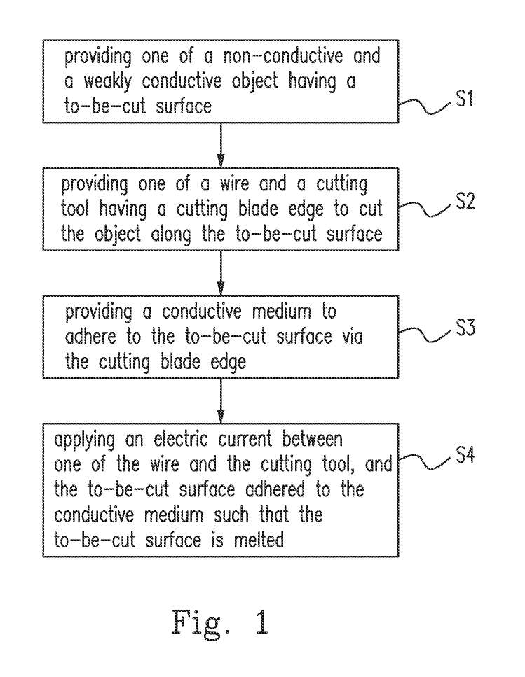

FIG. 1 is a schematic flow chart showing the WEDM method of an embodiment in the present invention.

The present invention relates to a WEDM method for cutting a nonconductor or weak conductor, and the WEDM method includes the following steps:

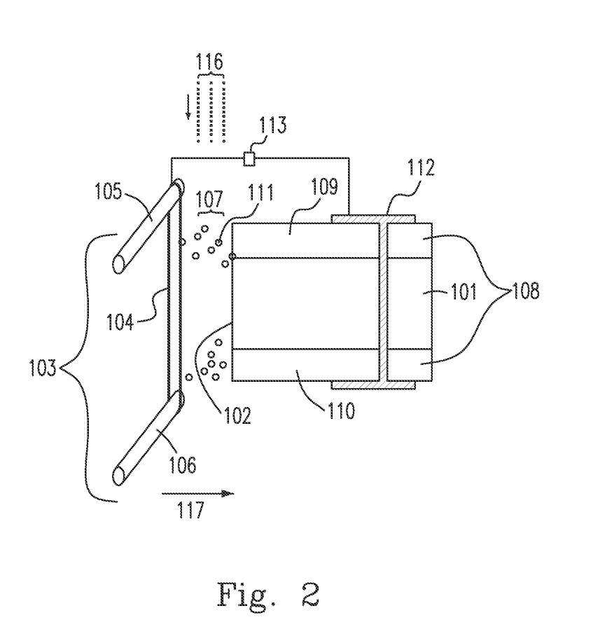

Step S1: as shown in FIG. 2, a non-conductive or a weakly conductive object 101 is first provided as a workpiece for processing, wherein the weak conductor is a poor conductor of heat or electricity, the non-conductive or the weakly conductive object 101 includes a to-be-cut surface 102, wherein the material of the non-conductive or the weakly conductive object 101 is preferably Silicon, monocrystalline silicon, polycrystalline silicon, SiC or another non-conductive or weakly conductive material.

Step S2: as shown in FIG. 2, a wire or a cutting tool 103 is provided, the wire or the cutting tool 103 has a cutting blade edge to cut the non-conductive or the weakly conductive object 101 along the to-be-cut surface 102, wherein the wire or the cutting tool 103 includes a wire conductor 104, a first axis 105 and a second axis 106 parallel to the first axis 105, the wire conductor is annularly configured around the first axis 105 and the second axis 106. Therefore, the wire conductor 104 is driven to rotate clockwise or counterclockwise by the rotation of the first axis 105 or the second axis 106, wherein the material of the wire conductor 104 is preferably an industrial wire including the elements copper, zinc, molybdenum alloy or another common industrial wires.

Step S3: as shown in FIG. 2, a conductive medium 107 is provided, the conductive medium 107 refers to any conductive material, wherein the conductive medium 107 is provided from a conductive medium source 108, the conductive medium source 108 refers to any material which can provide or produce a conductive medium. In the embodiment, the conductive medium source 108 is two metal pieces (a first metal piece 109 and a second metal piece 110) as an example, the two metal pieces are configured on the upper and lower surface of the non-conductive or the weakly conductive object 101, the conductive medium is metal slag 111, wherein the material of the two metal pieces can be the same or different, the conductive medium source 108 is not restricted to the two metal pieces in the present invention, at least one metal piece can be configured on the upper and lower surface of the non-conductive or the weakly conductive object 101, and the material of the metal piece can be any industrial metal including the elements aluminum, zinc, tin or another common industrial metal. Furthermore, the shape of the metal piece is not restricted in the present invention as long as the metal piece can touch the non-conductive or the weakly conductive object 101 to create a closed loop circuit in the WEDM process.

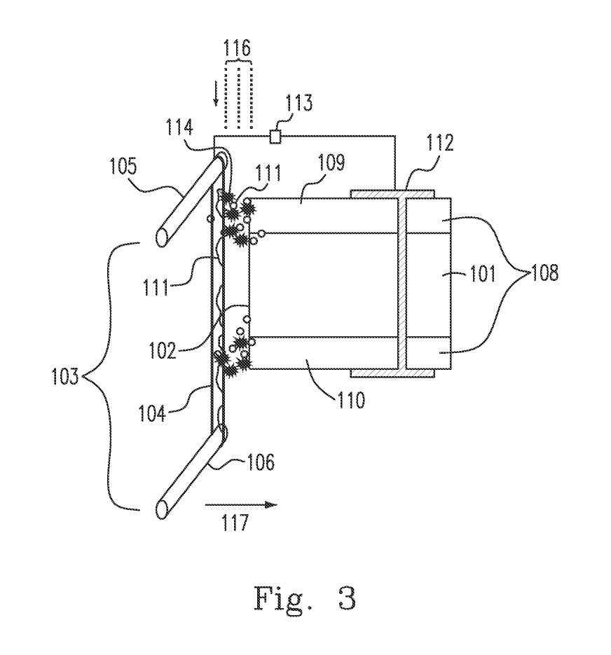

As shown in FIGS. 2-3, a conductive fixture 112 is configured to fix the two metal pieces and the non-conductive or the weakly conductive object 101 sandwiched therein, an electric current source 113 is electrically connected to the upper first metal piece 109 and the wire conductor 104, a first electrode of the electric current source 113 is directly or indirectly (via the conductive fixture 112, for example) electrically connected to the first metal piece 109 and the second metal piece 110, a second electrode of the electric current source 113 is electrically connected to the wire conductor 104, wherein the first electrode and the second electrode are respectively one of positive and negative electrodes, and the connection direction of the positive and negative electrodes depends on the materials used for the first metal piece 109 and the wire conductor 104.

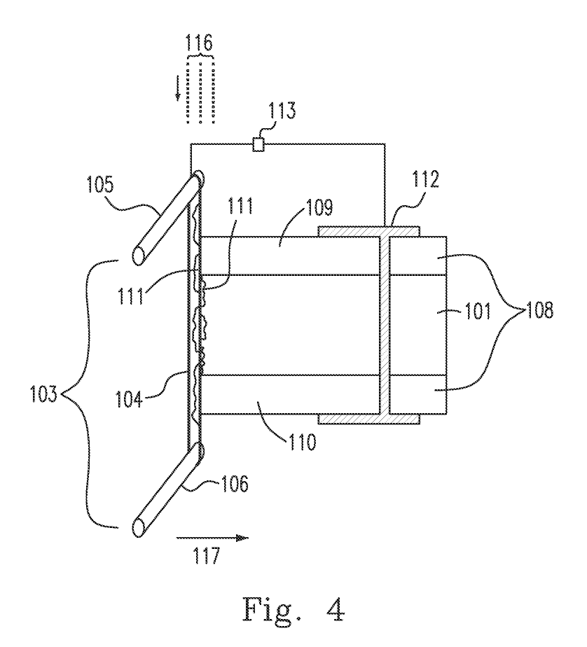

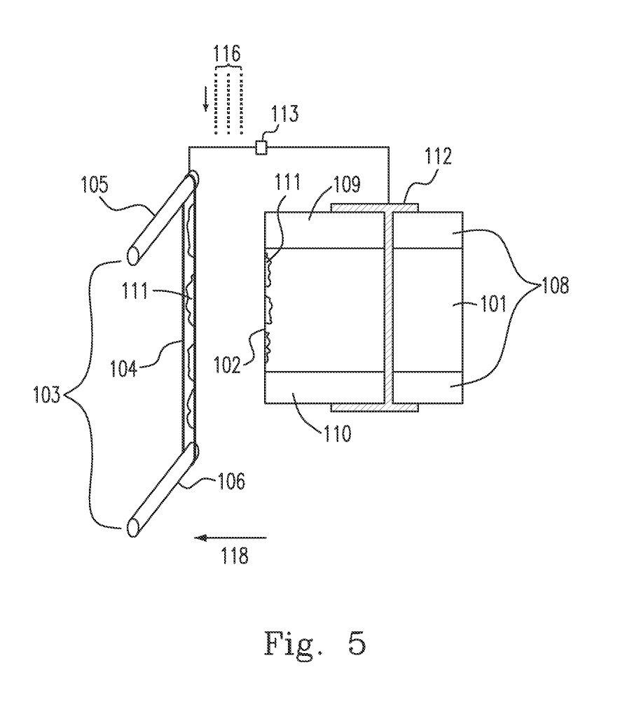

As shown in FIGS. 2-3, the wire conductor 104 is moved close to an edge of the first metal piece 109, the second metal piece 110 and the non-conductive or the weakly conductive object 101 in a first direction 117, by the application of an electric current (preferably ˜20A) and a voltage (preferably ˜100V) to evoke the electrical discharge effect 114 to the two metal pieces (the first metal piece 109 and the second metal piece 110) such that the two metal pieces are melted to release metal slag 111 on the wire conductor 104. Then, the wire conductor 104 is rotated clockwise or counterclockwise alternately such that the metal slag 111 adhered to the wire conductor 104 eventually adheres to (plates or welds) the to-be-cut surface 102 to the non-conductive or the weakly conductive object 101, or further permeates into the to-be-cut surface 102 to become alloying, and an electrically conductive loop is produced to start the electrical discharge. In the process of melting the two metal pieces via electrical discharge, the wire conductor 104 is moved close to an edge of the two metal pieces until the wire conductor 104 touches the two metal pieces such that a short circuit is produced, and the electrical discharge is stopped (as shown in FIG. 4). At this time, the wire conductor 104 is moved in a second direction 118 away from the two metal pieces and the to-be-cut surface 102 to maintain a predefined distance therebetween (as shown in FIG. 5). In addition, the conditions of the electric current and the voltage in the step can be adjusted according to the materials used for the two metal pieces and the non-conductive or the weakly conductive object 101.

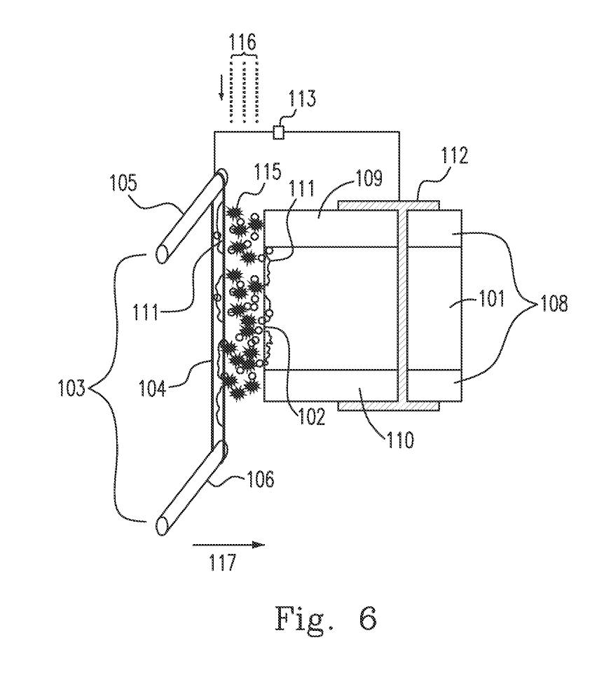

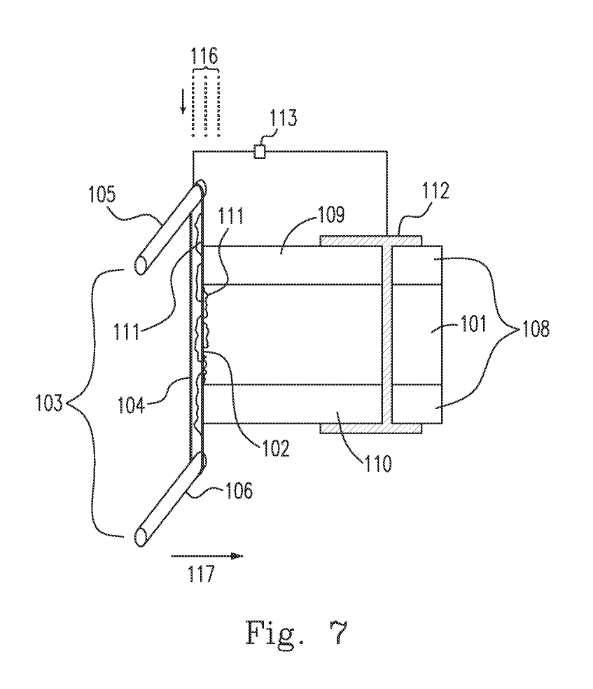

Step S4: as shown in FIG. 6, the wire conductor 104 is moved close to an edge of the first metal piece 109, the second metal piece 110 and the non-conductive or the weakly conductive object 101 again in a first direction 117, by the application of an electric current (preferably ˜5A) and a voltage (preferably ˜200V) and adjusting the pulse width, spacing, and electrical discharge waveform of the electric current and the voltage to evoke a dense, continuous electrical discharge to the non-conductive or the weakly conductive object 101 adhered to the metal slag 111 using a method of high electric current with short-duration pulses (the preferable electrical discharge period is ˜5 μs, and the preferable rest period is ˜20 μs), and the high temperature from the electrical discharge effect 115 can melt the to-be-cut surface 102 of the non-conductive or the weakly conductive object 101. In the process of cutting the non-conductive or the weakly conductive object 101 by electrical discharge, the wire conductor 104 is moved close to the non-conductive or the weakly conductive object 1.01 until the wire conductor 104 touches the non-conductive or the weakly conductive object 101 such that a short circuit is produced, and the electrical discharge is stopped (as shown in FIG. 7). At this time, the wire conductor 104 is moved in a second direction 118 again away from the two metal pieces and the to-be-cut surface 102 to maintain a predefined distance therebetween. In addition, the parameters of the electric current, the voltage, the electrical discharge period and the rest period in the step can be adjusted according to the materials of the two metal pieces and the non-conductive or the weakly conductive object 101.

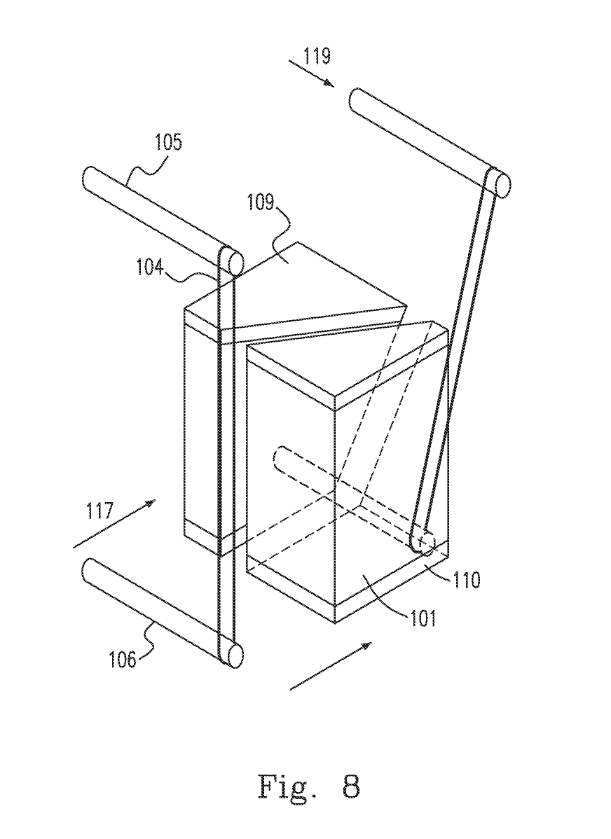

Next, the steps S3-S4 are repeated continually to achieve the cutting manufacturing process for the non-conductive or the weakly conductive object 101. In the process of step S3, step S4 and repeated steps S3-S4, a cutting fluid 116 is sprayed (as shown in FIGS. 2-7) to remove the oxide slag generated when the electric current is used to avoid an unexpected short circuit, by adjusting the flow and supply of the cutting fluid 116 to maintain unblocked on the to-be-cut surface 102 at all times, and the to-be-cut surface 102 is filled with the cutting fluid 116 to remove the oxide slag. In addition, in order that the electrical discharge effect is not influenced by the insufficient metal slag 111, the thickness of the first metal piece 109 and second metal piece 110 may be increased. In addition, in the cutting process steps above, if the wire conductor 104 is moved close to the two metal pieces (the first metal piece 109 and the second metal piece 110) and the non-conductive or the weakly conductive object 101 in a first direction 117 and the wire conductor 104 is maintained perpendicular to the floor in the process of approaching and cutting, the shape cut out is a plane. If the wire conductor 104 is maintained perpendicular to the floor only in the process of approaching and the first axis 105 is moved in a third direction 119 in the process of cutting such that the wire conductor 104 is not perpendicular to the floor any more, the shape cut out can be any other shape besides a plane (as shown in FIG. 8). Therefore, in this embodiment, the non-conductive or the weakly conductive object 101 can be cut out into any shape via the electrical discharge effect by changing the movement directions of the first axis 105 or the second axis 106. In addition, other related elements such as a conductive fixture, an electric current source and a cutting fluid as shown in FIGS. 2-7 are not indicated in the FIG. 8.

According to the embodiment above in the present invention, the electrical discharge induces three effects as follows:

1. The metal pieces are melted from the electrical discharge effect to release the metal slag on the wire conductor 104, then the metal is welded on the to-be-cut surface 102 of the non-conductive or the weakly conductive object 101 via the touch between the wire conductor 104 and the non-conductive or the weakly conductive object 101, and an electrically conductive loop is produced.

2. After the metal pieces are melted from the electrical discharge effect, the tiny metal particles are spilled, the tiny metal particles flow to the to-be-cut surface 102 of the non-conductive or the weakly conductive object 101 via the cutting fluid 116 such that a continuous electrical discharge is produced on the to-be-cut surface 102.

3. There is no need to immerse the workpiece in the cutting fluid 116 during the electrical discharge effect. Instead, an open system is maintained on the to-be-cut surface 102 for the convenience of removing the oxide slag and the flow of the metal slag.

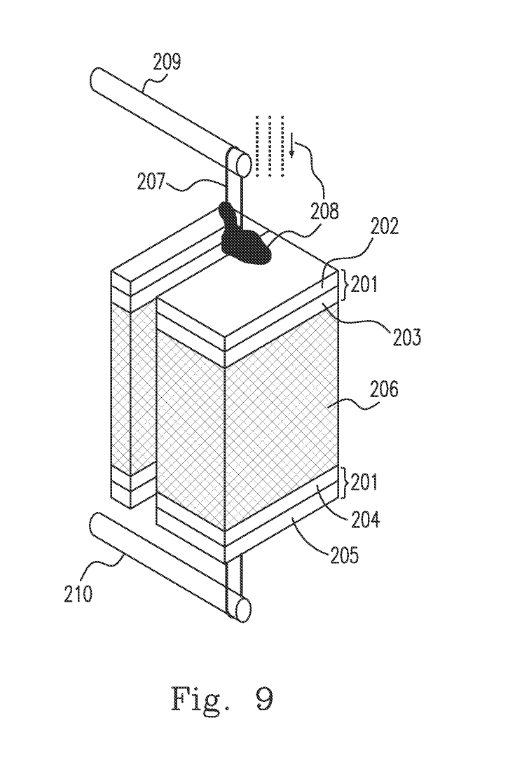

FIG. 9 is a schematic diagram showing the WEDM method of another embodiment in the present invention, including the WEDM configuration and arrangement in the manufacturing process. In this embodiment, the conductive medium source 201 consists of four metal pieces (a first metal piece 202, a second metal piece 203, a third metal piece 204 and a fourth metal piece 205) as an example, the first metal piece 202 and the second metal piece 203 are configured on the upper surface of the non-conductive or the weakly conductive object 206, the third metal piece 204 and the fourth metal piece 205 are configured on the lower surface of the non-conductive or the weakly conductive object 206, wherein the material of the four metal pieces can be the same, different or partially the same. In addition, the number, material, shape of the metal piece and the WEDM method in this embodiment are the same as the descriptions in the embodiment above, other related elements such as a conductive fixture and an electric current source in the embodiment are the same as the descriptions in the embodiment above and therefore are not indicated in FIG. 9. As shown in FIG. 9, the wire conductor 207 is used in the WEDM method as in the embodiment above, the non-conductive or the weakly conductive object 206 is melted by the high temperature from the electrical discharge effect in the cutting machining process, the material of the wire conductor 207 is the same as the descriptions in the embodiment above, wherein a cutting fluid 208 is sprayed to maintain unblocked on the to-be-cut surface and remove the oxide slag generated from the high temperature to avoid an unexpected short circuit,

FIG. 2 is a schematic diagram showing the WEDM apparatus of one embodiment in the present invention, the WEDM apparatus is used to apply the WEDM to a non-conductive or a weakly conductive object 101, wherein the weak conductor is a poor conductor of heat or electricity, and the non-conductive or a weakly conductive object 101 includes a to-be-cut surface 102. In this invention, the WEDM apparatus includes: a wire or a cutting tool 103, a conductive medium source 108, a conductive fixture 112, an electric current source 113 and a cutting fluid 116. The wire or the cutting tool 103 has a cutting blade edge to cut the non-conductive or the weakly conductive object 101 along the to-be-cut surface 102; the conductive medium source 108 can provide a conductive medium 107, wherein the conductive medium 107 can adhere to the to-be-cut surface 102 via the cutting blade; the conductive fixture 112 is configured to fix the conductive medium source 108 and the non-conductive or the weakly conductive object 101; the electric current source 113 includes a first electrode and a second electrode, the first electrode of the electric current source 113 is directly or indirectly (via the conductive fixture 112, for example) electrically connected to the conductive medium source 108, the second electrode of the electric current source 113 is electrically connected to the wire or the cutting tool 103, and thus an electric current is used between the wire or the cutting tool 103 and the to-be-cut surface 102 adhered to the conductive medium 107 such that the to-be-cut surface 102 is melted; a cutting fluid 116 is configured to be sprayed between the wire or the cutting tool 103, the conductive medium source 108 and the to-be-cut surface 102 to remove the oxide slag generated when the electric current is used and reduce the temperature of the wire or the cutting tool 103, by adjusting the flow and supply of the cutting fluid 116 to maintain unblocked on the to-be-cut surface 102 at all times, and the to-be-cut surface 102 is filled with the cutting fluid 116 to remove the oxide slag.

The non-conductive or the weakly conductive object 101 has a surface adjacent to the to-be-cut surface 102, the conductive medium source 108 is two metal pieces (a first metal piece 109 and a second metal piece 110) as an example configured on the surface, the conductive medium is metal slag 111, a voltage is used between the wire or the cutting tool 103 and the two metal pieces such that the two metal pieces are melted to release metal slag 111 on the wire or the cutting tool 103, wherein the wire or the cutting tool 103 includes a wire conductor 104, a first axis 105 and a second axis 106 parallel to the first axis 105, the wire conductor is annularly configured around the first axis 105 and the second axis 106, the wire conductor 104 is driven to rotate clockwise or counterclockwise by rotating the first axis 105 or the second axis 106 such that the metal slag 111 adhere to the wire conductor 104 adheres to the to-be-cut surface 102, and the machining process is the same as steps S1-S4 above. In addition, in this embodiment, the material of the non-conductive or a weakly conductive object 101 is preferably Silicon, monocrystalline silicon, polycrystalline silicon, SiC or another non-conductive or weakly conductive material, the material of the wire conductor 104 is preferably an industrial wire including the elements copper, zinc, molybdenum alloy or other common industrial wires, the material of the two metal pieces can be the same or different, the conductive medium source 108 is not restricted to the two metal pieces in the present invention, at least one metal piece can be configured on the upper and lower surface of the non-conductive or the weakly conductive object 101 (two metal pieces are configured on the upper and lower surface as shown in FIG. 9), and the material used for the metal piece can be any industrial metal including the elements aluminum, zinc, tin or another common industrial metal. Furthermore, the shape of the metal piece is not restricted in the present invention as long as the metal piece can touch the non-conductive or the weakly conductive object 101 to create a closed loop circuit in the WEDM process.

### Embodiments

Embodiment 1: A wire electrical discharge machining (WEDM) method, the WEDM method comprising steps of: (a) providing one of a non-conductive and a weakly conductive object having a to-be-cut surface; (b) providing one of a wire and a cutting tool having a cutting blade edge to cut the object along the to-be-cut surface; (c) providing a conductive medium to adhere to the to-be-cut surface via the cutting blade edge; and (d) applying an electric current between the one of the wire and the cutting tool, and the to-be-cut surface adhered to the conductive medium such that the to-be-cut surface is melted.

Embodiment 2: The WEDM method in Embodiment 1, further comprising repeating steps (c)-(d).

Embodiment 3: The WEDM method in Embodiment 1 or 2, wherein the step (e) further comprises a step of spraying a cutting fluid to remove oxide slag generated when the electric current is applied.

Embodiment 4: The WEDM method in Embodiments 1-3, wherein the object has a surface adjacent to the to-be-cut surface, and step (c) further comprises: (c1) providing a conductive medium source, wherein the conductive medium source is a metal piece configured on the surface.

Embodiment 5: The WEDM method in Embodiments 1-4, wherein the conductive medium is metal slag, and step (c) further comprises: (c2) moving the one of the wire and the cutting tool close to an edge of the metal piece and the to-be-cut surface in a first direction, applying a voltage between the metal piece and the one of the wire and the cutting tool such that the metal piece is melted to release the metal slag on the one of the wire and the cutting tool to adhere to the to-be-cut surface; and (c3) after the one of the wire and the cutting tool touches the edge of the metal piece and the to-be-cut surface, moving the one of the wire and the cutting tool in a second direction away from the edge of the metal piece and the to-be-cut surface.

Embodiment 6: The WEDM method in Embodiments 1-5, wherein the one of the wire and the cutting tool includes a wire conductor, a first axis and a second axis parallel to the first axis, wherein the wire conductor is annularly configured around the first axis and the second axis, and step (c2) comprises: (c21) rotating one of the first axis and the second axis to drive the wire conductor such that the metal slag adhered to the wire conductor eventually adheres to the to-be-cut surface.

Embodiment 7: The WEDM method in Embodiments 1-6, wherein the step (d) further comprises: (d1) moving the one of the wire and the cutting tool close to an edge of the metal piece and the to-be-cut surface in a first direction, applying the electric current until the one of the wire and the cutting tool touches the edge of the metal piece and the to-be-cut surface; and (d2) moving the one of the wire and the cutting tool in a second direction away from the edge of the metal piece and the to-be-cut surface.

Embodiment 8: The WEDM method in Embodiments 1-7, wherein the conductive medium in step (c) further permeates into the to-be-cut surface.

Embodiment 9: A wire electrical discharge machining (WEDM) apparatus for applying the WEDM on one of a non-conductive and a weakly conductive object, wherein the one object has a to-be-cut surface, comprising: one of a wire and a cutting tool having a cutting blade to cut the object along the to-be-cut surface; a conductive medium source providing a conductive medium to adhere to the to-be-cut surface via the cutting blade; and an electric current source for applying an electric current between the one of the wire and the cutting tool and the to-be-cut surface adhered to the conductive medium such that the to-be-cut surface is melted.

Embodiment 10: The WEDM apparatus in Embodiment 9, wherein the object has an upper surface adjacent to the to-be-cut surface, the conductive medium source is a metal piece configured on the upper surface, and the conductive medium is metal slag.

Embodiment 11: The WEDM apparatus in Embodiment 9 or 10, wherein a voltage is applied between the one of the wire and the cutting tool and the metal piece such that the metal piece is melted, the metal slag is released, and the metal slag eventually adheres to the one of the wire and the cutting tool.

Embodiment 12: The WEDM apparatus in Embodiments 9-11, wherein the one of the wire and the cutting tool includes a wire conductor, a first axis and a second axis parallel to the first axis, the wire conductor is annularly configured around the first axis and the second axis, and one of the first axis and the second axis is rotated to drive the wire conductor such that the metal slag adhered to the wire conductor adheres to the to-be-cut surface.

Embodiment 13: The WEDM apparatus in Embodiments 9-12, further comprising a conductive fixture, wherein the electric current source includes a first electrode and a second electrode, the conductive fixture is configured to fix the conductive medium source and the object, the first electrode is electrically connected to the conductive medium source, and the second electrode is electrically connected to the one of the wire and the cutting tool.

Embodiment 14: A wire electrical discharge machining (WEDM) apparatus for applying the WEDM to one of a non-conductive and a weakly conductive object, wherein the one object has a to-be-cut surface, comprising: one of a wire and a cutting tool having a cutting blade to cut the object along the to-be-cut surface; and a conductive medium source providing a conductive medium to adhere to the to-be-cut surface via the cutting blade, wherein the to-be-cut surface is melted by an application of an electric current between the one of the wire and the cutting tool and the to-be-cut surface adhered to the conductive medium.

Embodiment 15: The WEDM apparatus in Embodiment 14, further comprising an electric current source for applying the electric current.

Embodiment 16: The WEDM apparatus in Embodiment 14 or 15, wherein the object has an upper surface adjacent to the to-be-cut surface, the conductive medium source is a metal piece configured on the upper surface, and the conductive medium is metal slag.

Embodiment 17: The WEDM apparatus in Embodiments 14-16, wherein a voltage is applied between the one of the wire and the cutting tool and the metal piece such that the metal piece is melted, the metal slag is then generated, and the metal slag adheres to the one of the wire and the cutting tool.

Embodiment 18: The WEDM apparatus in Embodiments 14-17, wherein the one of the wire and the cutting tool includes a wire conductor, a first axis and a second axis parallel to the first axis, the wire conductor is annularly configured around the first axis and the second axis, and one of the first axis and the second axis is rotated to drive the wire conductor such that the metal slag adhered to the wire conductor adheres to the to-be-cut surface.

Embodiment 19: The WEDM apparatus in Embodiments 14-18, further comprising a conductive fixture, wherein the electric current source includes a first electrode and a second electrode, the conductive fixture is configured to fix the conductive medium source and the object, the first electrode is electrically connected to the conductive medium source, and the second electrode is electrically connected to the one of the wire and the cutting tool.

Embodiment 20: The WEDM apparatus in Embodiments 14-19, wherein the conductive medium further permeates into the to-be-cut surface.

According to the embodiments above of the WEDM method in this invention, two metal pieces are melted to release the metal slag on the wire conductor, then the metal slag is transferred to the to-be-cut surface of the non-conductive or the weakly conductive object via the touch between the wire conductor and the non-conductive or the weakly conductive object, a closed loop circuit is created via the touch between the wire conductor and the non-conductive or the weakly conductive object adhered to the metal slag, and a high temperature is produced by evoking an electrical discharge effect to melt the to-be-cut surface of the non-conductive or the weakly conductive object. In the manufacturing process, the following drawbacks of the traditionally abrasive wire cutting machining can be overcome: the produced cutting stress could crack the workpiece and change the size thereof, the cutting thickness is restricted, the cutting accuracy is bad, the machining efficiency and the material removal rate (MRR) decreases, and difficult material choices and a high manufacturing cost burden are involved when applied to a cutting operation for a semiconductor.

However, there are also the following advantages in this invention:

1. In the WEDM method of the present invention, there is no restriction to the residual stress and cutting thickness, and there is no need to immerse the workpiece in an electrolyte for electroplating: or other dipping bath operations, etc., which achieves an energy-saving effect.

2. In the WEDM method of the present invention, a manufacturing process is developed by using heat as cutting energy, which is sufficient to improve production efficiency and reduce the manufacturing process costs.

3. In the WEDM method of the present invention, high machining accuracy is achieved, the 300 μm cutting thickness restriction has been overcome to achieve a theoretical 50 μm cutting thickness.

4. In the WEDM method of the present invention, according to the embodiments above, the non-conductive or the weakly conductive object can be cut rapidly and continuously, and the cutting efficiency is three times greater than traditional cutting machining.

While the invention has been described in terms of what are presently considered to be the most practical and preferred embodiments, it is to be understood that the invention need not be limited to the disclosed embodiments. On the contrary, it is intended to cover various modifications and similar arrangements included within the spirit and scope of the appended claims which are to be accorded with the broadest interpretation so as to encompass all such modifications and similar structures. Therefore, the above description and illustrations should not be taken as limiting the scope of the present invention which is defined by the appended claims.

What is claimed is:

1. A wire electrical discharge machining (WEDM) method, the WEDM method comprising steps of:
(a) providing one of a non-conductive and a weakly conductive objects having a to-he-cut surface;
(b) providing one of a wire and a cutting tool having a cutting blade edge to cut the object along the to-be-cut surface;
(c) providing a conductive medium to be adhered to the to-be-cut surface via the cutting blade edge; and
(d) applying an electric current between the one of the wire and the cutting tool, and the to-be-cut surface adhered with the conductive medium such that the to-be-cut surface is melted.

2. The WEDM method as claimed in claim 1, further comprising steps:
repeating steps (c)-(d).

3. The WEDM method as claimed in claim 2, wherein the step (e) further comprises a step of spraying a cutting fluid to remove an oxide slag generated when the electric current is applied.

4. The WEDM method as claimed in claim 1, wherein the object has a surface adjacent to the to-be-cut surface, and the step (c) further comprises:
(c1) providing a conductive medium source, wherein the conductive medium source is a metal piece configured on the surface.

5. The WEDM method as claimed in claim 4, wherein the conductive medium is a metal slag, and the step (c) further comprises:
(c2) moving the one of the wire and the cutting tool close to an edge of the metal piece and the to-be-cut surface in a first direction, applying a voltage between the metal piece and the one of the wire and the cutting tool such that the metal piece is melted to release the metal slag on the one of the wire and the cutting tool to be adhered to the to-be-cut surface; and
(c3) after the one of the wire and the cutting tool touches the edge of the metal piece and the to-be-cut surface, moving the one of the wire and the cutting tool in a second direction away from the edge of the metal piece and the to-be-cut surface.

6. The WEDM method as claimed in claim 5, wherein the one of the wire and the cutting tool includes a wire conductor, a first axis and a second axis parallel to the first axis, wherein the wire conductor is annularly configured around the first axis and the second axis, and the step (c2) comprises:
(c21) rotating one of the first axis and the second axis to drive the wire conductor such that the metal slag adhered to the wire conductor eventually adheres to the to-be-cut surface.

7. The WEDM method as claimed in claim 4, wherein the step (d) further comprises:
(d1) moving the one of the wire and the cutting tool close to an edge of the metal piece and the to-be-cut surface in a first direction, applying the electric current until the one of the wire and the cutting tool touches the edge of the metal piece and the to-be-cut surface; and
(d2) moving the one of the wire and the cutting tool in a second direction away from the edge of the metal piece and the to-be-cut surface.

8. The WEDM method as claimed in claim 1, wherein the conductive medium in the step (c) further permeates into the to-be-cut surface.

9. A wire electrical discharge machining (WEDM) apparatus for applying the WEDM on one of a non-conductive and a weakly conductive objects, wherein the one object has a to-be-cut surface, comprising:
one of a wire and a cutting tool having a cutting blade to cut the object along the to-be-cut surface;
a conductive medium source providing a conductive medium to be adhered to the to-be-cut surface via the cutting blade; and
an electric current source for applying an electric current between the one of the wire and the cutting tool and the to-be-cut surface adhered with the conductive medium such that the to-be-cut surface is melted.

10. The WEDM apparatus as claimed in claim 9, wherein the object has an upper surface adjacent to the to-be-cut surface, the conductive medium source is a metal piece configured on the upper surface, and the conductive medium is a metal slag.

11. The WEDM apparatus as claimed in claim 10, wherein a voltage is applied between the one of the wire and the cutting tool and the metal piece such that the metal piece is melted, the metal slag is released, and the metal slag eventually adheres to the one of the wire and the cutting tool.

12. The WEDM apparatus as claimed in claim 11, wherein the one of the wire and the cutting tool includes a wire conductor, a first axis and a second axis parallel to the first axis, the wire conductor is annularly configured around the first axis and the second axis, and one of the first axis and the second axis is rotated to drive the wire conductor such that the metal slag adhered on the wire conductor adheres to the to-be-cut surface.

13. The WEDM apparatus as claimed in claim 9, further comprising a conductive fixture, wherein the electric current source includes a first electrode and a second electrode, the conductive fixture is configured to fix the conductive medium source and the object, the first electrode is electrically connected to the conductive medium source, and the second electrode is electrically connected to the one of the wire and the cutting tool.

14. A wire electrical discharge machining (WEDM) apparatus for applying the WEDM on one of a non-conductive and a weakly conductive objects, wherein the one object has a to-he-cut surface, comprising:
one of a wire and a cutting tool having a cutting blade to cut the object along the to-be-cut surface; and
a conductive medium source providing a conductive medium to be adhered to the to-be-cut surface via the cutting blade, wherein the to-be-cut surface is melted by an application of an electric current between the one of the wire and the cutting tool and the to-be-cut surface adhered with the conductive medium.

15. The WEDM apparatus as claimed in claim 14, further comprising an electric current source for applying the electric current.

16. The WEDM apparatus as claimed in claim 15, wherein the object has an upper surface adjacent to the to-be-cut surface, the conductive medium source is a metal piece configured on the upper surface, and the conductive medium is a metal slag.

17. The WEDM apparatus as claimed in claim 16, wherein a voltage is applied between the one of the wire and the cutting tool and the metal piece such that the metal piece is melted, the metal slag is then generated, and the metal slag adheres to the one of the wire and the cutting tool.

18. The WEDM apparatus as claimed in claim 17, wherein the one of the wire and the cutting tool includes a wire conductor, a first axis and a second axis parallel to the first axis, the wire conductor is annularly configured around the first axis and the second axis, and one of the first axis and the second axis is rotated to drive the wire conductor such that the metal slag adhered to the wire conductor adheres to the to-be-cut surface.

19. The WEDM apparatus as claimed in claim 14, further comprising a conductive fixture, wherein the electric current source includes a first electrode and a second electrode, the conductive fixture is configured to fix the conductive medium source and the object, the first electrode is electrically connected to the conductive medium source, and the second electrode is electrically connected to the one of the wire and the cutting tool.

20. The WEDM apparatus as claimed in claim 14, wherein the conductive medium further permeates into the to-be-cut surface.
